(19) United States
(12) Patent Application Publication
(10) Pub. No.: US 2016/0215376 A1
(43) Pub. Date: Jul. 28, 2016

(54) ZINC-BASED ANTI-CORROSION COATING FOR STEEL SHEETS, FOR PRODUCING A COMPONENT AT AN ELEVATED TEMPERATURE BY HOT FORMING DIE QUENCHING

(71) Applicant: SALZGITTER FLACHSTAHL GMBH, Salzgitter (DE)

(72) Inventors: FRIEDRICH LUTHER, HANNOVER (DE); MARC DEBEAUX, Braunschweig (DE)

(73) Assignee: SALZGITTER FLACHSTAHL GMBH, Salzgitter (DE)

(21) Appl. No.: 14/915,810

(22) PCT Filed: Jul. 24, 2014
(86) PCT No.: PCT/DE2014/000393

§ 371 Date: Mar. 1, 2016

(30) Foreign Application Priority Data
Sep. 2, 2013 (DE) 10 2013 015 032.9

(51) Int. Cl. C23C 2/06; C22C 18/00; B32B 15/01; C21D 1/18; C21D 9/46; C21D 9/52; C22C 18/04; C23C 2/28

(52) U.S. Cl. CPC C23C 2/06; C22C 18/04; C22C 18/00; C23C 2/28; C21D 1/18; C21D 9/46; C21D 9/52; B32B 15/013

(57) ABSTRACT

A zinc-based anti-corrosion coating is disclosed for steel sheets or steel strips, which for the purpose of hardening are at least in parts heated to a temperature above Ac3 and then cooled at a temperature situated at least partially above the critical cooling speed, the anti-corrosion coating being a coating applied by hot dipping. In addition to at least 75% by weight zinc and possible unavoidable impurities, the coating also contains 0.5 to 15.0% by weight manganese and 0.1 to 10.0% by weight aluminium

The invention relates to a zinc-based anti-corrosion coating for steel sheets, which are hardened in a hot forming process with the features of patent claim 1.

It is known that hot-formed steel sheets are increasingly used in particular in the automobile construction. The process, also referred to as press quenching, enables producing components, which are predominantly used in the vehicle body. The press quenching can generally be conducted by means of two different process variants, i.e. by means of the direct or indirect method.

In the direct method a steel plate is heated above the so-called austenitizing temperature, subsequently the thusly heated plate is transferred into a forming tool and formed into the finished component in a single-stage forming step and is hereby cooled at the same time by the cooled forming tool with a cooling rate which is above the critical hardening cooling rate of the steel, thereby producing a hardened component.

In the indirect method the component is first almost completely formed, optionally in a multi-stage forming process. This formed component is then also heated to a temperature above austenitizing temperature and transferred to and inserted into a forming tool, which already has the dimensions of the component or the final dimensions of the component. After closing the in particular cooled tool, the pre-formed component is only cooled in this tool with a cooling rate above the critical hardening cooling rate and thereby hardened.

Known hot-formable steels for these applications are for example the manganese-boron steel “22MnB5” and recently also air hardened steels according to DE 10 2010 024 664 A1.

Beside uncoated steel sheets, also steel sheets with a anti corrosion coating are increasingly demanded and used by the automobile industry. The advantages in this case are beside the increased corrosion-resistance of the finished component also that the plates or components do not scale in the furnace, which reduces wear of the press quenching tools due to detached scale and the components do not have to be laboriously blasted prior to further processing.

Currently used during press hardening are coatings applied by hot dip coating, which are made of aluminum-silicone (AS), zinc-aluminum (Z), zinc-aluminum-iron (ZF/Galvannealed), and electrolytically precipitated coatings made of zinc-nickel. These anti-corrosion coatings are usually applied to the hot or cold strip in continuous methods.

The advantage of zinc-based anti-corrosion coatings is that they not only have a barrier effect like aluminum based coatings, but in addition offer an active cathodic corrosion protection for the component.

The press quenching of steel plates with zinc-based coatings is known from DE 601 19 826 T2. Here a steel sheet, which was previously heated above austenitizing temperature to 800-1200° C. and was optionally provided with a metallic coating of zinc or zinc based coating, is formed in a tool, which may be cooled depending on the circumstances, by hot forming into a component, wherein during the forming the steel sheet or component is quench hardened (press quenching) as a result of fast heat withdrawal and obtains the demanded strength properties as a result of the generated martensitic hardened microstructure.

However zinc-based systems have a disadvantage. In particular in the direct press quenching of zinc-based anti-corrosion coatings it is known that during the forming step macro-cracks (>100 um) can form in the steel in the surface-proximate region, which may sometimes even extend through the entire cross section of the steel sheet. Even smaller micro-cracks can already lower the durability of the steel and thus prevent its use.

A cause for the occurrence of cracks is stress corrosion due to zinc phases, which is also referred to as liquid metal assisted cracking (LMAC) or liquid metal embrittlement (LME). Hereby the austenite grain boundaries of the steel are infiltrated and weakened by liquid zinc phases, which may lead to deep cracks especially in regions with high tensions or forming degrees.

One way to address this problem is to use indirect press quenching in the case of zinc-based coatings, because in this case the actual forming step is performed prior to the hardening at ambient temperatures. Even though cracks may also occur during the hardening and residual forming in the tool, the depth of the cracks is significantly smaller compared to the cracks in the direct process, and because they usually do not exceed the permitted crack depth, they are considered harmless.

However, the indirect method is much more laborious because it requires an additional work step (cold forming) and on the other hand special furnaces for the heating have to be used in which the components as opposed to plates can be heated prior to the hardening.

A further possibility is the method for producing a hardened steel component with a coating of zinc or a zinc alloy described in DE 10 2010 056 B3, wherein the plate, independent of the thickness of the zinc layer or the thickness of the zinc-alloy layer, is held at a temperature of above 782° C. prior to the forming for an amount of time so that a barrier layer of zinc-ferrite forms between the steel and the coating of zinc or a zinc alloy and takes up liquid zinc and has a thickness that prevents liquid zinc phases from reacting with the steel during forming.

The term zinc-ferrite in this context means an iron-zinc solid solution in which the zinc atoms are substitutionally dissolved in the iron crystal lattice. As a result of the low zinc content the melting point of the zinc-ferrite is above the forming temperature. In praxis, however, it was shown that in components produced according to this method, due to the high iron content in the alloy layer, the cathodic corrosion protection of the finished component is only very low. In addition, the process window for the heating is very narrow because liquid metal embrittlement can occur when heating times are too short and no cathodic corrosion protection is present when heating times are too long.

A further possibility is the method for producing a hardened steel component described in EP 2 414 563 B1, wherein a single-phase zinc-nickel-alloy layer made of [gamma]ZnNi-phase is electrolytically precipitated, which beside zinc and unavoidable impurities contains 7 to 15 weight % nickel, a plate made from the steel product is heated to a plate temperature of at least 800° C. and is then formed in a forming tool and cooled with a cooling rate sufficient to form the heat tempered or hardened microstructure.

The nickel content increases the melting point of the alloy layer so that during the hot forming no liquid zinc phase and with this no liquid metal ebrittlement can occur. However, this method has the disadvantage that the nickel content poses a health hazard during processing when nickel dust or nickel vapors are inhaled.

It is an object of the invention to set forth a metallic coating for directly press quenched components made of steel, which effectively prevents liquid metal embrittlement during hot forming and in addition ensures a high cathodic corrosion protection of the formed component, without elements being contained which may be regarded as a potential health hazard during production and processing.

According to the teaching of the invention, the object is solved by a coating for a steel sheet or strip to be formed by press quenching, which is composed at least of 75 weight % zinc, 0.5 weight % manganese and 0.1 to 10 weight % aluminum.

Tests have surprisingly shown that plates with a coating, which beside zinc and aluminum in addition contains a sufficient amount of manganese can be directly press-hardened without a thick zinc-ferrite layer, i.e., after very short heating times, without the occurrence of liquid metal embrittlement. The effect is hereby not based on an increase of the melting point of the coating above the forming temperature but according to tests is based on the presence of manganese in the region of the interface between the steel and the coating. As a result no liquid metal embrittlement occurs even in the presence of liquid zinc phases during forming.

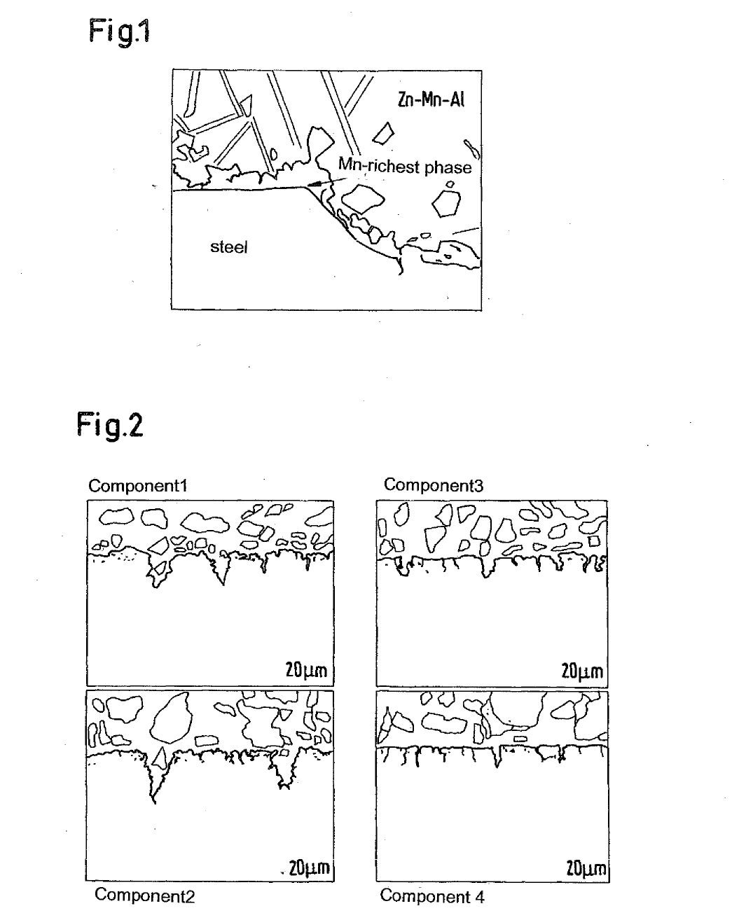

FIG. 1 shows a scanning electron microscopic image of the transverse microsection of a Zn—Mn—Al anti-corrosion layer in the transition region steel-coating. Even though the mechanism of the embrittlement-inhibiting effect of the manganese content in the coating is not yet clear, manganese-containing phases are nevertheless detectable in the coating at the interface to the steel in the starting state prior to the hot forming, which manganese containing phases form instead of the Fe₂Al₅Znₓ-inhibition layers and/or zinc-iron-phases otherwise known in the hot dip coating.

Because liquid metal embrittlement does not occur at sufficiently high manganese contents, no minimal annealing time for forming a thick zinc-ferrite layer prior to the direct hot forming is required or respectively only the time for reaching the required forming temperature is required. In FIG. 2 the 90° bending shoulders of directly formed components are comparatively shown after very short heating times (180 seconds) to 900° C. While in the reference samples (22MnB5+Zn140) the cracks extend deep into the basic material, the cracks in the case of 22MnB5 with a coating according to the invention end at the transition from the alloy layer to the steel substrate.

As a result of the short heating times, a high zinc content in the alloy layer of the finished component can thus be retained, which significantly improves cathodic corrosion protection. With increasing manganese content in the coating also the melting point increases, which complicates the process of the continuous hot dip coating or renders it entirely impracticable. In addition the zinc content, which is important for the cathodic corrosion protection, decreases. For ensuring a sufficient corrosion protection in combination with a liquid metal ebmrittlement-inhibiting effect it is therefore provided that the content of zinc in the coating is at least 75 weight % and the content of manganese in the coating is 0.5 to 15 weight %. With increasing manganese content, however, also the melting point of the zinc-based zinc anti-corrosion layer and with this also the required melting bath temperature increases, which increases the technical effort and also energy costs. For this reason it is advantageous when the manganese content is 0.5 to 5.0 weight % and further preferred 0.5 to 3.0 weight %. The stated contents have to be regarded as averaged value, because manganese-rich phases particularly form at the interface to the steel substrate.

The addition of aluminum at contents of 0.1 to 10 weight % is required for the formation of an aluminum oxide layer on the surface of the coating during the heating to austenitizing temperature, which aluminum oxide layer protects the coating—in particular the zinc proportion—against evaporation or a massive oxidation. Also aluminum increases the melting point of the zinc-based anti-corrosion coating and with this also the required hot dip bath temperature. In addition the service life of the bath fixtures decreases with increasing aluminum content in the melt. For these reasons it is advantageous when the aluminum content is preferably 0.1 to 2.0-weight % and further preferred 0.1 to 1.0-weight %.

If needed the coating can be converted into a zinc-iron-manganese-aluminum alloy layer already during the continuous hot dip coating process by immediate heating when leaving the hot dip bath (galvannealing-treatment). This may be advantageous for a fast heating of the plates prior to the hot forming, for example by induction, because this reduces the evaporation risk of the alloy layer as a result of increasing the iron content.

The thickness of the coating can be between 1 μm and 25 μm depending on the demands placed on the corrosion protection, wherein also greater thicknesses are possible.

The method according to the invention is also suited for coating hot rolled or cold rolled flat steel products.

Beside the use for press form hardened components for the automobile industry the anti-corrosion coating according to the invention can also be advantageously used for steel products in other industry areas, which are generally exposed to a temperature stress during further processing by forming and/or tempering and in the finished component have to have a sufficient corrosion protection. These may for example include steel sheets that are formed into plowshares and subsequently hardened for agricultural machine construction, quenched and tempered heavy plates or rolled sections for building construction or machine construction.

The essential advantages of the invention can be summarized as follows:
The iron content of the alloy layer of the finished component can be significantly lower and the zinc content thus significantly higher than in components with the known zinc-based hot dip coatings, which ensures a significantly improved cathodic corrosion protection.
The process window during hot forming is wider compared to the known zinc-based hot dip coatings, because no minimal furnace times are required or respectively only the time until reaching the forming temperature.
During further processing no health-compromising nickel dust and/or vapors are created compared to electrolytical zinc-nickel coatings. No nickel-containing media are required during production.

1.-9. (canceled)

10. A zinc-based anti-corrosion coating for steel sheets or steel strips, which are hardened by heating at least in regions of the steel sheets or steel strips to a temperature above Ac3 and cooling the steel sheets or steel strips with a cooling rate which at least in regions is above a critical cooling rate, said anti-corrosion coating being applied by hot dip coating in a hot dip bath, said anti-corrosion coating having a zinc content of at least 75 weight %, a manganese content of 0.5 to 15.0 weight % and aluminum content of 0.1 to 10.0 weight %, and unavoidable impurities.

11. The zinc-based anti-corrosion of claim 10, wherein the manganese content is 0.5 to 5.0 weight %, and the aluminum content is 0.1 to 2.0 weight %.

12. The zinc-based anti-corrosion coating of claim 10, wherein the manganese content is 0.5 to 3.0 weight %, and the aluminum content is 0.1 to 1.0 weight %.

13. The zinc-based anti-corrosion coating of claim 10, wherein the zinc-based anti-corrosion coating is convertible into a zinc-manganese-aluminum-iron-alloy layer by an immediate heating after exit form the hot dip bath.

14. The zinc-based anti-corrosion coating according to claim 10, wherein the coating or the alloy layer has a thickness between 1 and 25 micrometers.

15. A method for producing a zinc-based anti-corrosion coating for steel sheets or steel strips, comprising applying the zinc-based anti-corrosion coating onto a steel sheet or steel strip, are hardened by heating at least regions of the steel sheet or steel strip to a temperature above Ac3 and cooling the steel sheets or steel strips with a cooling rate which at least in regions is above a critical cooling rate, said anti-corrosion coating having a zinc content of at least 75 weight %, a manganese content of 0.5 to 15.0 weight % and aluminum content of 0.1 to 10.0 weight %, and unavoidable impurities.

16. A steel sheet or steel strip, produced by
hardening the steel sheet or steel strip by heating at least regions of the steel sheet or steel strip to a temperature above Ac3 and cooling the steel sheet or steel strip with a cooling rate which at least in regions is above a critical cooling rate, said steel sheet or steel strip having an anti-corrosion coating which has a zinc content of at least 75 weight %, a manganese content of 0.5 to 15.0 weight % and aluminum content of 0.1 to 10.0 weight %, and unavoidable impurities.

17. A zinc-based anti-corrosion coating for use for steel products that are subjected to forming at temperatures above 500° C., said zinc-based anti-corrosion coating having a zinc content of at least 75 weight %, a manganese content of 0.5 to 15.0 weight % and aluminum content of 0.1 to 10.0 weight %, and unavoidable impurities.

18. The zinc-based anti-corrosion coating of claim 17, for use in plowshares, heavy plates or rolled sections.
